(19) United States
(12) Patent Application Publication
(10) Pub. No.: US 2009/0089326 A1
(43) Pub. Date: Apr. 2, 2009

(54) METHOD AND APPARATUS FOR PROVIDING MULTIMEDIA CONTENT OPTIMIZATION

(75) Inventor: Srinivasan Balasubramanian, San Jose, CA (US)

Correspondence Address: MPG, LLP AND YAHOO! INC., 710 LAKEWAY DRIVE, SUITE 200, SUNNYVALE, CA, 94085, US

(73) Assignee: YAHOO!, INC., SUNNYVALE, CA (US)

(21) Appl. No.: 11/864,370

(22) Filed: Sep. 28, 2007

(51) Int. Cl. G06F 7/20

(52) U.S. Cl. 707/104.1; 707/E17.009

(57) ABSTRACT

Methods, system and computer readable medium for detecting duplicate content in a pair of media files prior to publication on a webpage include generating fingerprints for the contents of each of the pair of media files. The fingerprints of one of the pair of media file are then compared with the fingerprints of another of the pair of media files to compute a similarity score. The similarity score is compared against an established threshold. If the similarity score exceeds the established threshold, it is determined that the two media files are substantial duplicate of one another.

### FIELD OF THE INVENTION

This invention relates to Content Management and Publishing Systems for publishing multimedia content on webpages, and more specifically to providing multimedia content optimization prior to publishing the multimedia content on a webpage.

### BACKGROUND

Detection of duplicate content and providing content optimization is an important problem in many data mining and information filtering applications. Duplicate content in a pair of multimedia files can be defined by the appearance of exact syntactic terms and sequence of content in both multimedia content files, with or without formatting differences or can be defined as having similar content. With the proliferation of information on the internet, it is essential that contents received and aggregated from various sources are fully optimized prior to publishing on a web page in an organized fashion. Typically, one or more Content Management and Publishing Systems (CMPS) are employed to assimilate and publish the information content received from various sources. CMPS is a software system application that enables organization, control, addition, publication and/or manipulation of a large number of information content on a website. The information content may pertain to computer files, image media files, audio files, electronic documents and various other multimedia resource contents. CMPS also facilitates archiving information content for later retrieval/publishing.

Typically, some of the information content captured by various sources relate to the same topic or event. Currently available CMPS and search engines for developing/generating web pages of information are equipped with software, hardware and/or firmware to identify and eliminate duplicate information content from being published on a webpage by verifying for syntactic duplicates. Syntactic duplicates are determined by examining the sources and sequence of information content from one or more sources. If the sources and/or sequence of information content from the sources are the same, then the information content from the sources is said to be duplicates of each other. In such case, the CMPS may be equipped with logic to publish the information content from only one source. However, when the sequence of information content from different sources covering the same event/topic have different sequences of information, but include essentially the same descriptive information, the CMPS is unable to identify the information content as substantial duplicates, even though the event covered and the subject matter are the same. When the information content from these sources are processed by the CMPS, the information content from both sources, linking to the same story, are published resulting in duplicates thereby robbing valuable screen real-estate from web pages. Currently, there is no means to provide multimedia content optimization by controlling or preventing duplicate stories from being published on a webpage.

It is in this context that embodiments of the invention arise.

### SUMMARIES OF THE INVENTION

Several distinct embodiments are presented herein as examples, including methods, systems, and computer readable media that allow for detection of duplicate multimedia files prior to publishing the multimedia files on a webpage. The embodiments include generating fingerprints for the content of each multimedia file. The fingerprints define feature set of the contents of each of the multimedia file. The generated fingerprints are compared between multimedia files to determine if any of the multimedia files are substantial duplicates of one another. The detection of duplicate content in a pair of multimedia files will enable a publishing service or tool to publish one and not both the multimedia files thereby saving precious real estate space on the webpage. In other embodiments, even if some files have some similar content, it is possible to define a level of similarity that is acceptable. In this manner, multiple multimedia files having some similarity may be published, however, the similarity will not exceed some established threshold.

In one embodiment, a method for detecting duplicate content in a pair of media files prior to publication on a webpage, is described. According to this embodiment, fingerprints are generated for the contents of each of the pair of media files. The fingerprints of one media file are then compared with the fingerprints of another media file to obtain a similarity score. If the similarity score exceeds an established threshold value, it is determined that the pair of media files are substantial duplicates of each other. Thus, the embodiment of the invention is used to identify duplicate media files so that only distinct media files may be published on the webpage thereby saving real-estate space on the webpage.

In another embodiment, a method for optimizing content of multimedia files to be published on a webpage, is described. According to this embodiment, multimedia files that are to be published on the webpage are identified. A similarity score is computed for the identified multimedia files based on the contents of the media files. A containment percentage score for the identified media files is determined. The media files are ranked based on a pre-defined metric using the similarity scores and containment percentage scores. The pre-defined metric may include one or more established thresholds for comparing the similarity scores and containment scores of the media files to determine the ranking of the media files. One or more multimedia files are then published on the webpage based on the ranking of the multimedia files.

In yet another embodiment, a system for detecting duplicate content in multimedia files is described. The system comprises a backend server that is configured to receive the multimedia files from plurality of content providers over a communication network. A duplicate detection software module is available to the backend server. The duplicate detection software module is configured to compute a similarity score for the received multimedia files based on the content of the multimedia files. The system further includes a publish server to publish an appropriate multimedia file on the webpage based on the similarity score. The system may further include a ranking algorithm that is available to the backend server for ranking the multimedia files so that the multimedia files may be published based on the ranking.

In another embodiment, a computer readable medium having program instructions for detecting duplicate content in a pair of multimedia files is described. The computer readable medium includes program instructions for receiving multimedia files and generating fingerprints for the contents of each of the pair of multimedia files. The computer readable medium further includes program instructions for comparing the fingerprints of the pair of multimedia files to obtain a similarity score. Program instruction to compare the similarity score against an established threshold is included. If the similarity score exceeds the established threshold value, then the pair of multimedia files is considered substantial duplicates of one another. Thus, the computer readable medium includes program logic to identify duplicate media files so that only distinct media files may be published on the webpage thereby saving real-estate space on the webpage.

### BRIEF DESCRIPTION OF THE DRAWINGS

FIG. 1 is a schematic overview illustrating a server system, in one embodiment of the invention.

FIGS. 2A and 2B represent an overview of a sliding window used in detecting duplicate content in multimedia files, in one embodiment of the invention.

FIGS. 2C and 2D illustrate the fingerprints generated for the pair of documents illustrated in FIGS. 2A and 2B, in one embodiment of the invention.

FIGS. 3A through 3D illustrate sliding window and fingerprints for a pair of documents in an alternate embodiment of the invention.

FIG. 4 illustrates flowchart of operations involved in detecting duplicate contents in multimedia files, in one embodiment of the invention.

FIG. 5 illustrates flowchart of operations involved in optimizing contents of multimedia files, in another embodiment of the invention.

### DETAILED DESCRIPTION OF THE INVENTION

The present invention includes a mechanism that can identify duplicate contents in multimedia files so that only essential multimedia files may be identified and published on the webpage. The mechanism may be used in preventing a plurality of multiple multimedia files covering the same topic or event from being published thereby saving essential screen real-estate space on a webpage.

With the proliferation of information on the Internet, search engines and publishing systems/services focus on detecting duplicate content so that the ensuing webpages are free of redundant information. A pair of multimedia files may be broadly categorized as either being syntactic duplicates or semantic duplicates. The pair of multimedia files are classified as being syntactic duplicates when the content of one multimedia file mirrors the other multimedia file. Search engines focus on identifying and eliminating syntactic duplicates. The pair of multimedia files are classified as being semantic duplicates when the multimedia files cover the same event or topic with substantially similar factual content but are presented in distinct styles i.e. two write-ups of same story. It is essential that the publishing systems focus on eliminating semantic duplicates so that the ensuing webpage covers diverse range of events/topics and is not bogged down by the coverage of single event/topic from multiple sources.

The mechanism comprises generating fingerprints for the content of each multimedia file. The fingerprints define feature set of the content of each multimedia file. The generated fingerprints for a pair of multimedia files are compared to obtain similarity score for the multimedia files. The pair of multimedia files is declared substantial duplicates when the similarity score for the multimedia files exceed an established threshold. Using this mechanism a webpage may be designed such that only distinct multimedia files are published thereby eliminating redundant multimedia coverage for the same topic or event. The size of the fingerprints may be customized so as to provide optimal and efficient detection of duplicate content in the multimedia files.

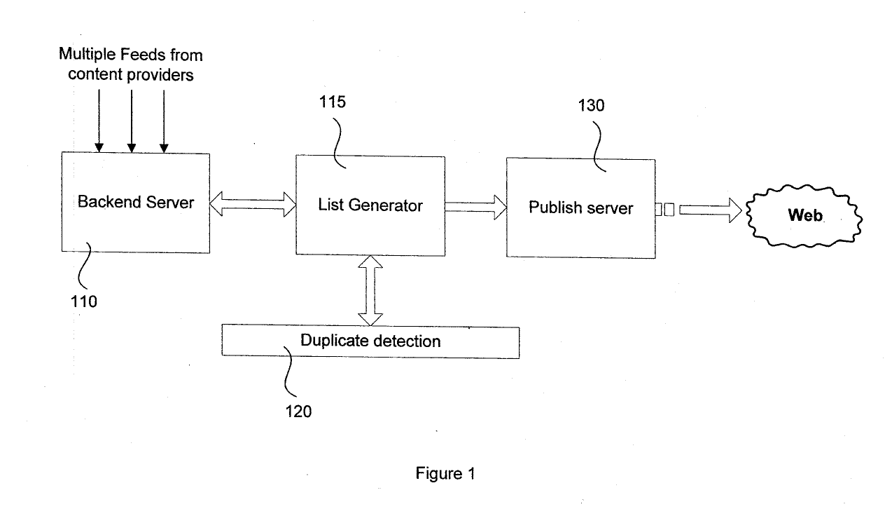

To facilitate an understanding of the various embodiments, a fundamental infrastructure of a server system will be described first and a detailed description of processes implementing the disclosed embodiments will be described with reference to the fundamental infrastructure. FIG. 1 illustrates a basic server system used in optimizing contents of multimedia files. The server system includes a backend server 110 for receiving multimedia (also referred to as media) files from a plurality of content providers. The backend server 110 is connected over a communication network to other servers on the internet to receive multimedia files from various content providers. The server system further includes a duplicate detection software module (also referred to as content optimizer) 120. The content optimizer 120 may reside on a separate server that is communicatively connected to the backend server 110 or may reside on the backend server 110. The content optimizer 120 is configured to receive the multimedia files from the backend server 110, generate fingerprints for each of the multimedia files based on the content and to compute a similarity score using the fingerprints for a pair of multimedia files. The content optimizer 120 is also used to compare the similarity scores for the pair of multimedia files against an established threshold to determine if the multimedia files are substantial duplicates of each other.

The server system further includes a publish server 130 that is used in publishing the appropriate media file onto a webpage over the internet. The publish server 130 is communicatively connected to the content optimizer 120 to receive the substantial duplicate media files for publishing on the webpage and may include content management and publishing tools for ranking and publishing multimedia files. In one embodiment, the publish server 130 may be integrated with the server on which the content optimizer 120 resides and the publishing tools are made available to the content optimizer 120. In one embodiment, the publishing tools may be integrated with the content optimizer 120 so that appropriate media file may be chosen for publishing based on the fingerprints and similarity score. In one embodiment, a ranking algorithm may be used to determine an appropriate media file for publication by the publish server 130. The ranking algorithm may be part of the content management and publishing tools or may be available to the content management and publishing tools to rank the multimedia files based on the similarity score and other pre-defined multimedia file metrics, such as size, type of content, ranking of content provider, monetization criteria, etc.

In addition to the backend server 110, content optimizer 120 and publish server 130, the server system may include a list generator 115. The list generator 115 is communicatively connected to the backend server 110 to receive the multimedia files and generate headlines (titles) for the received multimedia files. The list generator 115 is also communicatively connected to the content optimizer 120 so that fingerprints can be generated and similarity score computed for the generated titles of the received multimedia files. In one embodiment, the list generator 115 and the content optimizer 120 may reside on a single server and the backend server 110 and publish server 130 are communicatively connected to this server on which the content optimizer 120 and the list generator 115 reside. Alternatively, the list generator 115 and content optimizer 120 may be integrated into the publish server 130 or into the backend server 110.

The mechanism of the content optimizer 120 will now be discussed in detail with reference to the fundamental infrastructure of the server system. The content optimizer 120 uses a concept called “fingerprint” to determine if contents of particular media files are substantial duplicates of one another. Fingerprint, as used in this application, is defined as a set of hash values computed by using a concept called a “sliding window.” The sliding window is defined as a partially overlapping window of constant width that is moved by a pre-determined length over the entire length of a media file. At each position of the sliding window, hash value is computed for that particular sliding window. The set of hash values defining the contents of the media files represent the fingerprint or feature set.

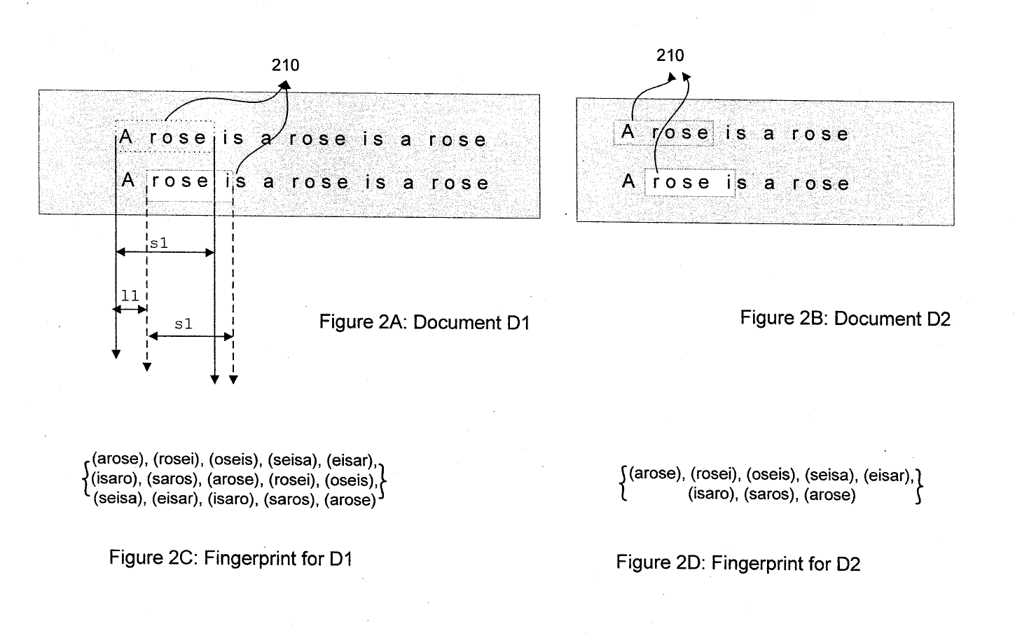

FIGS. 2A and 2B illustrate the concept of the sliding window used in determining the feature set or the fingerprint of a pair of media files, D1 and D2. Media files D1 and D2 depict a pair of simple text documents that are used in determining the similarity score using a content optimizer 120. The text of the documents D1 and D2 are sub-divided or segmented into a plurality of partially overlapping strings of a pre-determined width, s1. The string segment of constant width s1, is called a sliding window 210 and the length of partial overlap is called overlay (11). The entire text of the documents D1 and D2 are segmented by moving the sliding window 210 across the length of the document by an overlay at a time. Hash value at each position of the sliding window 210 is calculated to define feature set or fingerprints for each document, D1 and D2. In one embodiment, the length of the overlay for moving the sliding window 210 is one byte. The overlay is not restricted to one byte but is exemplary only. FIGS. 2C and 2D illustrate the fingerprints of the two documents, D1 and D2, depicted in FIGS. 2A and 2B, respectively. As can be seen, the fingerprints for the two documents are obtained by moving the sliding window 210 one byte at a time across the length of the documents, D1 and D2. The content optimizer 120 uses the defined fingerprints of the two documents D1 and D2 to compute a similarity score. In one embodiment, the similarity score is calculated using a formula (F(D1)∩F(D2))/(F(D1) U F(D2)). It should be noted that the formula used in computing similarity score is exemplary and is not to be construed exhaustive and as such other formulae or means may be used to determine the similarity score.

Further, to determine the similarity score using the above formula, only distinct fingerprints from the two documents are considered, in one embodiment of the invention. Accordingly, using the above formula it is determined that the similarity score for the two documents illustrated in FIGS. 2A and 2B is 7/7 indicating that the two documents are 100% similar. This implies that the two documents are duplicates even though D1 includes additional text compared to D2. It is to be noted that the additional text includes strings that are repeats of earlier set of strings and hence are not distinct.

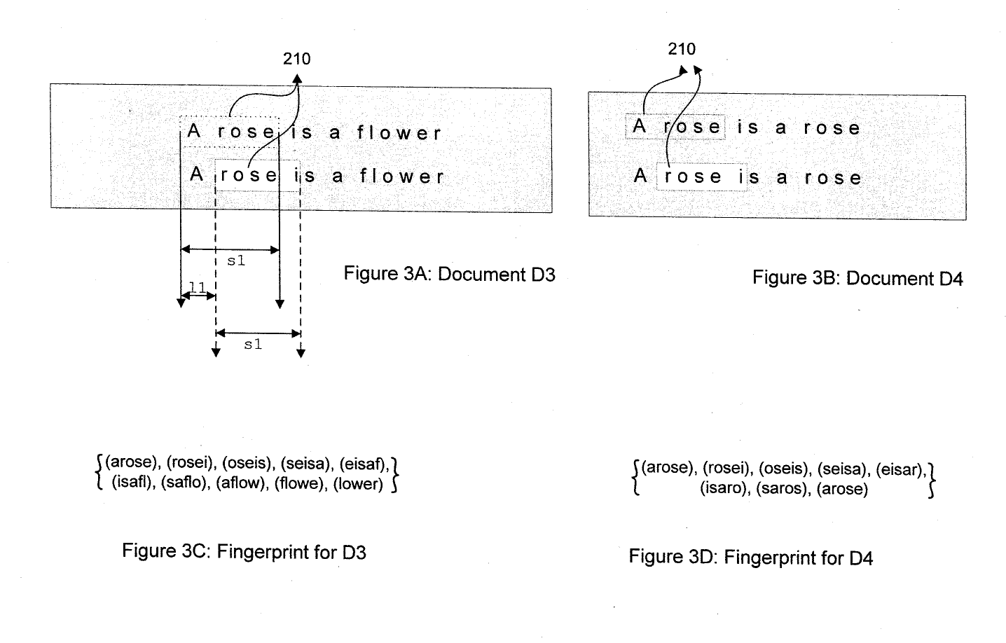

FIGS. 3A and 3B illustrate an alternate example of two media files, D3 and D4. As illustrated, media files D3 and D4 embody a pair of simple text documents that have at least a portion of dissimilar text. A content optimizer 120 is employed to define the fingerprints for the contents of the two documents, D3 and D4, as illustrated in FIGS. 3C and 3D. A similarity score is then computed by the content optimizer 120 using the formula mentioned earlier and the fingerprints of the two documents, D3 and D4. Based on the fingerprints, it is determined that the similarity score for documents D3 and D4 is 4/13 indicating that the two documents are about 30% similar.

The computed similarity score of the two documents is then compared against an established threshold. If the similarity score exceeds the established threshold, then the documents are considered substantial duplicates. For instance, if the established threshold is 25% and the computed similarity score of a pair of documents is 30% (as determined with respect to D3 and D4) then the documents are considered substantial duplicates as the computed similarity score exceeds the established threshold. The established threshold is configurable based on the nature and size of contents of the media files that are to be published. Based on the comparison, the documents are tagged as substantial duplicates and/or are grouped together so that they can be easily identified during publishing.

In one embodiment of the invention, each media file is normalized prior to the creation of fingerprints. The normalization process may include converting all textual contents of the media files to lower case, eliminating whitespaces, special characters and stop words, such as commas, semicolons, periods, etc., from the content. Although the embodiments of the invention have been described with respect to feature set of a pair of media files, the embodiments of the invention can be extended to determine the feature set for all media files which may be selected to appear on a webpage.

Several factors affect duplicate detection of media files. Some of the factors include width of the sliding window, s1, established threshold for similarity score, corpus size—the domain size of the media files and latency requirements for the content optimizer 120. With respect to the width of the sliding window, the higher the sliding window width the more sensitive it will be in detecting changes in document. However, a wider sliding window may result in less accurate detection of semantic duplicates as the wider sliding windows become more sensitive to changes. The advantage of using wider sliding windows is that it will be less expensive. It is, therefore, essential to determine the optimal sliding window size that will provide a more accurate detection while substantially reducing the cost of such accurate detection. The established threshold for similarity score is specific to the domain of the media files. As the established threshold is configurable, the threshold should be configured based on the media file domain such that it is low enough to cluster related documents while high enough to avoid arbitrary cluster. If the threshold is set too low, all media files will be similar.

In addition to developing fingerprints for the contents of the media files, an embodiment of the invention may include generating fingerprint for the title of each media files. In this embodiment, the content optimizer 120 does a two-pass duplicate detection testing. In the first pass, fingerprints for the headlines are created for each media file. Headlines are created for each media file using a list generator 115. As with the contents of the media file, the headlines may be normalized prior to the generation of the fingerprints. The generated fingerprints for the headlines of a pair of media files are used in computing the similarity score. If the similarity score for the headlines exceeds the established threshold, then the media files are considered substantial duplicates. In such a case, the contents of the media files are not verified. If, however, the similarity score for the headlines of the pair of media files falls under the established threshold, the contents of the media files are examined to determine if the contents of the media files are substantial duplicates. In this case, the content optimizer 120 proceeds to generate fingerprints for the contents of a pair of media files and computes similarity score by comparing the fingerprints of the two media files. The similarity score is then compared against an established threshold to determine if the contents are similar. If the similarity score for the contents of the two media files exceed the established threshold, then the contents of the media files are considered substantial duplicates. Using the two-pass duplicate detection, computing time to detect duplicate media files may be optimized.

In addition to computing similarity scores to detect substantially similar documents, the content optimizer 120 may be used to rank each of the substantially similar media files. The content optimizer 120, in this case, generates and uses a containment percentage score along with the similarity score to rank the media files. For instance, in order to rank a pair of media files, the content optimizer 120 first generates fingerprints and computes a similarity score to determine if the contents of the two media files are substantially similar. Once the two media files are deemed substantially similar, the two media files are grouped together. The content optimizer 120 is then used to compute containment percentage score for the two media files. The containment percentage score is computed by first analyzing the content in each media file to determine if the amount of content in one media file exceeds the content in another media file by a certain threshold. This first analysis is to determine which of the two media files is more relevant. Upon establishing the fact that the content of one media file exceeds the content of another media file by a certain threshold, a containment percentage score is computed for each media file based on the content. The threshold by which the content of one media file exceeds the other may be similar to the established threshold used for similarity scoring. The media files are then ranked based on pre-defined metric which may include the containment percentage score, similarity score, expected monetization yield, credibility of multimedia content provider, expected click-through, ranking of multimedia content provider, information density in each media file, etc. Based on the ranking of each media file, a publishing tool or service may determine which media files to publish on the webpage.

In cases where the media files include audio content, the audio content is converted to text and the content optimizer 120 uses the converted text to analyze and compute similarity score so that substantially duplicate media files may be detected. In cases where the media files include image files, video files, graphical user interface (GUI) files or any other media files that are non-textual or cannot be converted to textual documents, the contents of the media files are defined by metadata. In this case, the content optimizer 120 uses the metadata to analyze and compute similarity score so that substantially duplicate media files may be identified.

The embodiments of the invention may be implemented as a webservice. Accordingly, the webservice may receive a list of multimedia files as input and create another list of multimedia files that contain similar multimedia files ranked and grouped together. The webservice may be integrated with editorial publishing tools or CMPS to provide for duplicate-free webpages. The editorial publishing tools or CMPS may include logic that may rank similar multimedia files using a ranking algorithm or may use a pre-defined metric so that only distinct and relevant multimedia files are published on the webpage resulting in better quality webpages without duplicate media files or information.

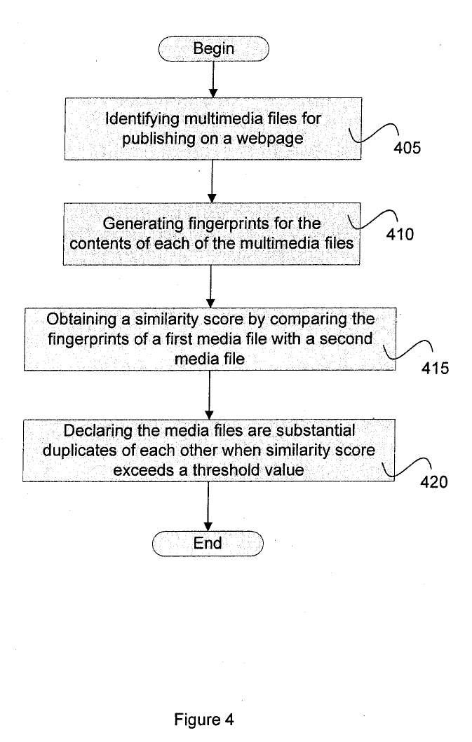

FIG. 4 illustrates flowchart of various operations involved in detecting duplicate content in media files. The process begins with identifying media files that may be included for publishing on a webpage, as shown in operation 405. The media files may include files covering a single topic or event that are received from various content providers. A content optimizer 120 is used to analyze the content of each media file and generate fingerprints, as illustrated in operation 410. The fingerprints are generated by using a concept called a “sliding window” wherein the media file is segmented into a sequence of slightly overlapping strings of constant width (window) which is slid across the entire length of the media file by a pre-determined length (overlay). The fingerprints define feature set of the contents of each media file. The content optimizer 120 uses the fingerprints of a pair of media files to compute similarity score for the media files, as illustrated in operation 415. The process concludes when the computed similarity score of the media files is verified against an established threshold. If the computed similarity score exceeds the established threshold, the pair of media files is declared substantial duplicate of one another, as illustrated in operation 420.

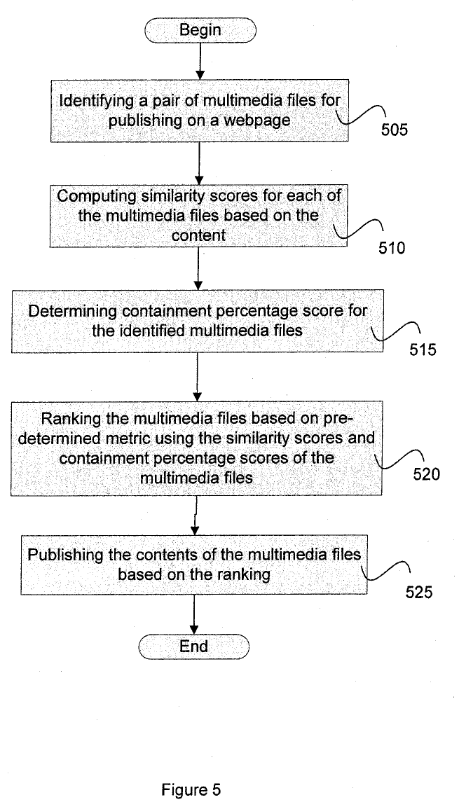

FIG. 5 illustrates flowchart of operations involved in publishing media files, in one embodiment of the invention. The process begins with identifying media files to be published on the webpage, as illustrated in operation 505. As in the previous embodiment, a plurality of media files covering same topic or event is received from one or more content providers. A content optimizer 120 is used to compute similarity scores for each of the identified media files, as illustrated in operation 510. The content optimizer 120 generates fingerprints for the content of each media file using the sliding window concept discussed earlier and then computing similarity score by analyzing the fingerprints. A containment percentage score is determined for the identified media files based on the content, as illustrated in operation 515. The containment percentage score is obtained by first analyzing the content in each media file to determine if the amount of content in one media file exceeds the content in another media file by a certain threshold. Upon determining that the content of one media file exceeds the content of a second media file by a certain threshold, a containment percentage score is computed for each media file based on the content. The media files are then ranked based on pre-defined metric which may include the containment percentage score, similarity score associated with the media files and other criteria such as expected monetization yield, credibility of multimedia content provider, expected click-through, ranking of multimedia content provider, information density in each media file, etc., as illustrated in operation 520. Based on the ranking of each media file, a publishing tool or service may be used to publish the appropriate multimedia file on the webpage, as illustrated in operation 525. The process concludes with the publishing of the appropriate multimedia files on the webpage based on the ranking.

The invention can also be embodied as computer readable code on a computer readable medium. The computer readable medium is any data storage device that can store data which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The computer readable medium includes program instructions for detecting duplicate content in multimedia files. The computer readable medium may be installed on or accessed by a server of a server system. The computer readable medium includes program instructions for receiving multimedia files and generating fingerprints for the content of each multimedia file. The computer readable medium further includes program instructions for comparing the fingerprints of one media file with the fingerprints of another media file to obtain a similarity score between the two media files. The computer readable medium further includes program instruction to compare the similarity score against an established threshold. If the similarity score exceeds the established threshold value, then the two multimedia files are considered substantial duplicates of one another. Thus, the computer readable medium includes program logic to identify duplicate media files so that only distinct media files may be published on the webpage thereby saving real-estate space on the webpage.

The invention may be practiced with other computer system configurations including hand-held devices, microprocessor systems, microprocessor-based or programmable consumer electronics, minicomputers, mainframe computers and the like. The invention may also be practiced in distributed computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

It will be obvious, however, to one skilled in the art, that the present invention may be practiced without some or all of these specific details. In other instances, well known process operations have not been described in detail in order not to unnecessarily obscure the present invention.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for detecting duplicate content in a pair of media files prior to publication on a webpage, the method comprising:
generating fingerprint for the content of each of the pair of media files, the fingerprint defining a feature set for each media file;
comparing the fingerprint of the pair of media files to obtain a similarity score; and
declaring the media files as substantial duplicates when the similarity score exceeds an established threshold.

2. The method for detecting duplicate content in a pair of media files prior to publication on a webpage of claim 1, wherein the media files are normalized prior to generating the fingerprint for the content of the media files.

3. The method for detecting duplicate content in a pair of media files prior to publication on a webpage of claim 2, wherein normalizing media files includes one or more of converting text to lower case, eliminating whitespaces, eliminating special characters and eliminating stop words.

4. The method for detecting duplicate content in a pair of media files prior to publication on a webpage of claim 1, wherein defining the feature set further comprising:
establishing a sliding window size;
segmenting each of the pair of media files into a plurality of strings, the width of each segment of the media files determined by the established sliding window size;
incrementing the sliding window over the length of the media files by a pre-determined length at a time; and
computing hash value over each segment of the pair of the media files.

5. The method for detecting duplicate content in a pair of media files prior to publication on a webpage of claim 4, wherein the similarity score is obtained by comparing the hash values for each segment of one media file with the hash value for each segment of another media file.

6. The method for detecting duplicate content in a pair of media files prior to publication on a webpage of claim 5, wherein the similarity score is obtained by comparing only distinct fingerprints of each of the pair of media files.

7. The method for detecting duplicate content in a pair of media files prior to publication on a webpage of claim 4, wherein the pre-determined length for incrementing the sliding window is one byte.

8. The method for detecting duplicate content in a pair of media files prior to publication on a webpage of claim 1, wherein the established threshold for the similarity score to exceed is configurable.

9. The method for detecting duplicate content in a pair of media files prior to publication on a webpage of claim 1, further comprising generating fingerprint for the title of each of the media files and determining similarity score for the titles of the pair of media files.

10. The method for detecting duplicate content in a pair of media files prior to publication on a webpage of claim 1, wherein the media files include one or more of text files, graphic user interface files, audio files, video files, or any other multimedia content files.

11. The method for detecting duplicate content in a pair of media files prior to publication on a webpage of claim 1, wherein the content of the media files are defined by one or more metadata and wherein the fingerprints are generated for the pair of media files using the metadata.

12. A method for publishing media files on a webpage, comprising:
identifying media files to be published on the webpage;
computing similarity scores for the identified media files based on contents of the media files;
determining a containment percentage score for the identified media files, the containment percentage score is associated with the content of the media files;
ranking the media files based on pre-defined metric using the similarity scores and containment scores of the identified media files, the pre-defined metric including one or more established thresholds for comparing the similarity scores and containment scores of the media files to determine the ranking of the media files; and
publishing the appropriate content of the media files based on the ranking of the media files.

13. The method for publishing media files on a webpage of claim 12, wherein computing similarity scores further including:
defining a sliding window size based on the content of the media files;
segmenting the content of each of the media files into a plurality of sections, the width of each section defined by the sliding window size, the plurality of sections obtained by incrementing the sliding window by one byte across the length of each of the media file; and
computing hash value for each section of the media file, the hash value used in determining the similarity score of each of the media file.

14. The method for publishing media files on a webpage of claim 12, wherein computing containment percentage score further including:
determining size of each of a pair of the media files;
calculating containment percentage of the contents of the media files when the size of a first media files exceeds the size of a second media file by a pre-defined threshold.

15. The method for publishing media files on a webpage of claim 12, wherein the contents of the media files are normalized, the normalization including one or more of converting text characters within the media files to lower case, eliminating whitespaces, eliminating special characters, and eliminating stop words.

16. The method for publishing media files on a webpage of claim 12, wherein the contents of the media files are defined by one or more metadata.

17. A system for detecting duplicate content in a pair of multimedia files prior to publication on a webpage, the system comprising:
a backend server to receive the multimedia files from a plurality of content providers, the backend server receiving the multimedia files over a communication network;
a duplicate detection software module available to the backend server, the duplicate detection software module configured to compute a similarity score for the content of the media files received from the plurality of content providers; and
a publish server to publish the multimedia files over the internet as a webpage.

18. The system for detecting duplicate content in a pair of multimedia files prior to publication on a webpage of claim 17, further comprising a list generator available to the backend server, the list generator configured to generate headlines for the available multimedia files at the backend server.

19. A computer readable medium in which program instructions are stored, the program instructions when read by a server of a computing system, cause the server to perform a method for detecting duplicate content in a pair of media files prior to publication on a webpage, the method comprising:
generating fingerprint for the content of each of the pair of media files, the fingerprint defining a feature set for each media file;
comparing the fingerprint of the pair of media files to obtain a similarity score; and
declaring the media files as substantial duplicates when the similarity score exceeds an established threshold.

20. The computer readable medium of claim 19, further comprising program instructions to normalize each of the pair of the media files prior to generating the fingerprint for the content of each media file, wherein normalization includes one or more of converting text in each media file to lower case, eliminating stop words, eliminating whitespaces and eliminating special characters.

21. The computer readable medium of claim 19, further comprising generating fingerprint for the title of each of the pair of media files and computing the similarity score for the titles of the pair of media files by comparing the fingerprints for the title.
